(19) United States
(12) Patent Application Publication
(10) Pub. No.: US 2026/0118194 A1
(43) Pub. Date: Apr. 30, 2026

(54) PET PULLING FORCE TEST DEVICE

(71) Applicant: Zheng YOU, Gaobeidian (CN)

(72) Inventor: Zheng YOU, Gaobeidian (CN)

(21) Appl. No.: 18/983,529

(22) Filed: Dec. 17, 2024

(30) Foreign Application Priority Data
Oct. 25, 2024 (CN) 202422594176.6

(51) Int. Cl. G01L 5/00; A01K 29/00; G01L 1/22

(52) U.S. Cl. CPC G01L 5/0033; A01K 29/00; G01L 1/22

(57) ABSTRACT

An embodiment of the present disclosure provides a pet pulling force test device including a force measuring device, which includes a housing. A force measuring structure, a detection circuit, a battery and a feedback device for feeding back pulling force states are arranged on the housing. The force measuring structure includes a sensor for testing a pulling force. The sensor, the feedback device and the battery are electrically connected to the detection circuit respectively. The force measuring structure is rotatably connected to the housing.

### CROSS-REFERENCE TO RELATED APPLICATIONS

This application claims priority benefits to Chinese Patent Application No. 2024225941766, filed on Oct. 25, 2024; the contents of which are incorporated herein by reference.

### TECHNICAL FIELD

The present disclosure relates to a pet pulling force test device.

### BACKGROUND

When walking pets, especially dogs, owners are required to keep them on a leash, particularly in public and crowded areas, to prevent them from running loose. If a pet's pulling force exceeds the leash's capacity, it may break, allowing the pet to escape and become uncontrollable. Some leashes indicate the maximum pulling force they can withstand, but pet owners often do not know how much force their pet can exert. Additionally, as pets grow, their pulling force changes. Generally, a dog's pulling force increases with age until it reaches a maximum. However, during this growth process, owners may not be aware of the changes in pulling force.

### SUMMARY

A pet pulling force test device includes a force gauge, which includes a housing, a force measuring structure, a detection circuit, a battery and a feedback device for feeding back a pulling force state. The force measuring structure, the detection circuit, the battery and the feedback device are arranged on the housing; the force measuring structure includes a sensor for testing a pulling force; the sensor, the feedback device and the battery are respectively electrically connected to the detection circuit; and the force measuring structure is rotatably connected to the housing.

### BRIEF DESCRIPTION OF DRAWINGS

The drawings constituting a part of the present disclosure are configured to provide a further understanding of the present disclosure. The embodiments of the present disclosure and their descriptions are used for explaining and do not constitute an improper limitation on the present disclosure.

FIG. 1 is a perspective view of a pet pulling force test device in accordance with the embodiments of the present disclosure.

FIG. 2 is an exploded view of a force gauge in accordance with the embodiments of the present disclosure.

FIG. 3 is a perspective view of a portion of a force gauge in accordance with the embodiments of the present disclosure.

FIG. 4 is another perspective view of FIG. 3.

FIG. 5 is another perspective of a force gauge in accordance with the embodiments of the present disclosure.

FIG. 6 is a sectional view taken along the line AA in FIG. 5.

FIG. 7 is a perspective view of a force measurement structure in accordance with the embodiments of the present disclosure.

FIG. 8 is a perspective view a force measurement structure in accordance with the embodiments of the present disclosure.

FIG. 9 is a perspective view of a force measurement structure in accordance with the embodiments of the present disclosure.

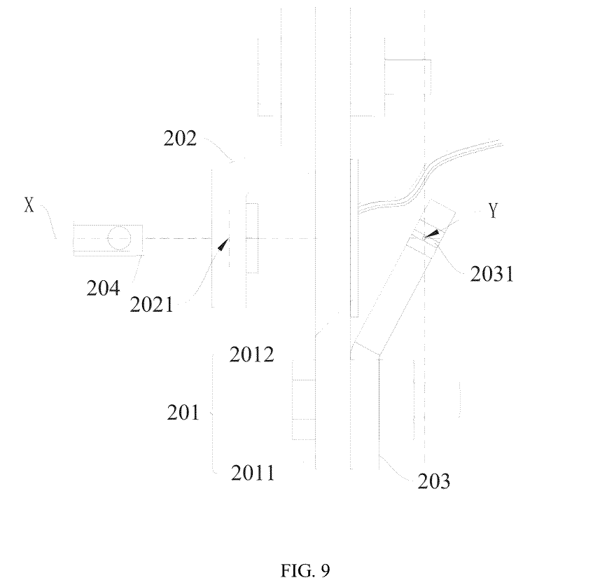

FIG. 10 is a perspective view of another force measurement structure in accordance with the embodiments of the present disclosure.

FIG. 11 is a perspective view of a panel in accordance with the embodiments of the present disclosure.

### DETAILED DESCRIPTION OF THE EMBODIMENTS

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of one embodiment may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical junction, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

According to some embodiments of the present disclosure, a pet pulling force test device is provided, which is configured to test the pulling force of a pet. A suitable traction rope 200 can be selected according to the magnitude of the pulling force. Moreover, it can also record the pet's pulling force during its growth process, with changes in the pulling force serving as a health indicator. In addition, the current pulling force can be used to match the pet with suitable individuals. For example, a pet having a greater pulling force is suitable for young and middle-aged people, but not for children and the elderly.

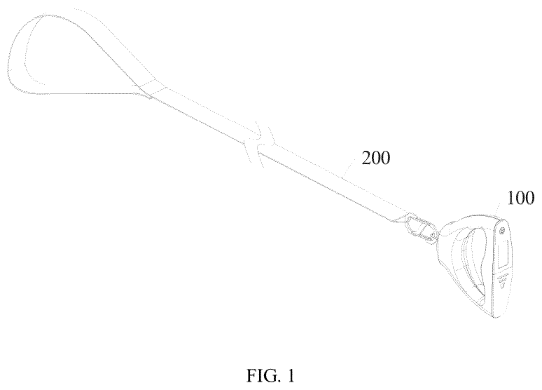

As shown in FIG. 1, the pet pulling force test device includes a force gauge 100 and a traction rope 200, one end of the traction rope 200 is connected to a force measuring end of the force gauge 100, and another end of the traction rope 200 is configured to attach to a pet.

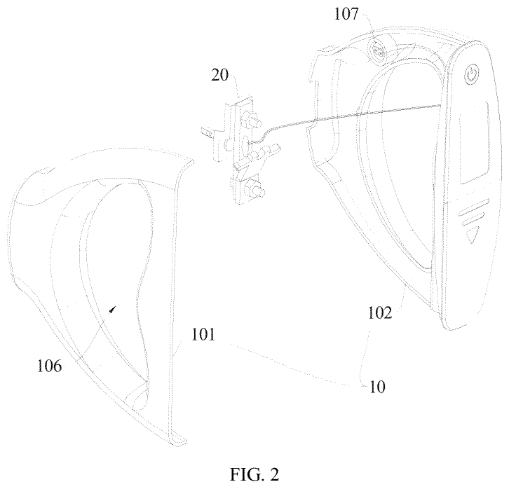

As shown in FIG. 2 to FIG. 4, the force gauge 100 includes a housing 10. A force measuring structure 20, a PCB board 104 and a battery 1051 are provided in the housing 10. The force measuring structure 20 includes a sensor 201 for testing a pulling force. The PCB board 104 is provided with a detection circuit 1041, the sensor 201 and the battery 1051 are respectively electrically connected to the detection circuit 1041, and the traction rope 200 is connected to a force measuring end of the force measuring structure 20. The force measuring structure 20 is rotatably arranged in the housing 10, and its function is to keep a direction of the pulling force and an angle of the sensor 201 within a preset range, ensuring that the sensor 201 to accurately measure the magnitude of the pulling force.

In some embodiments, the housing 10 includes a first housing 101 and a second housing 102. The force measuring structure 20, the PCB board 104 and the battery 1051 are all disposed between the first housing 101 and the second housing 102. The force measuring structure 20 is installed at a first end of the housing 10. The first end of the housing 10 is defined with a through hole 108, and one end of the traction rope 200 can be connected to the force measuring end of the force measuring structure 20 through the through hole 108.

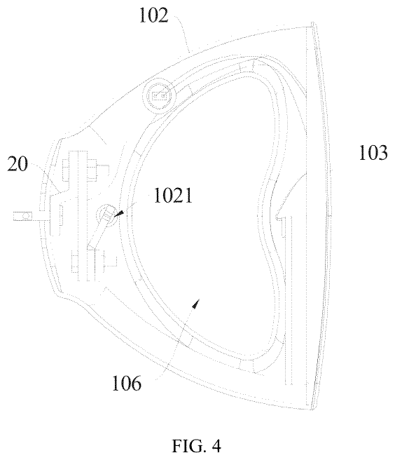

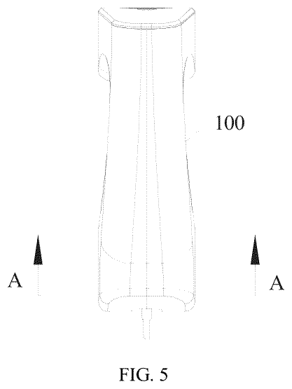

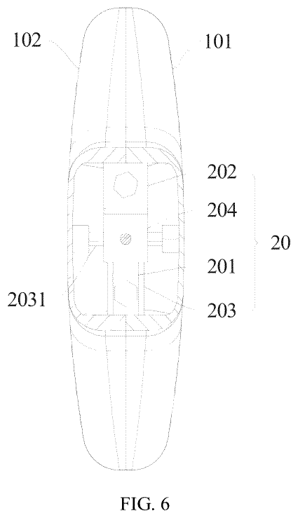

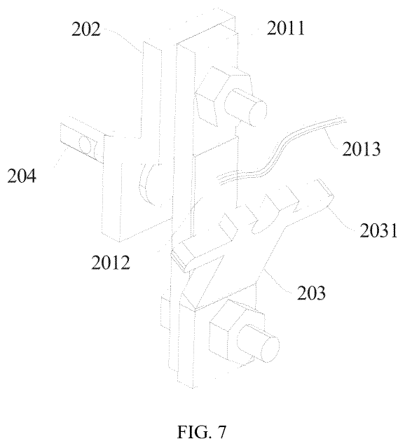

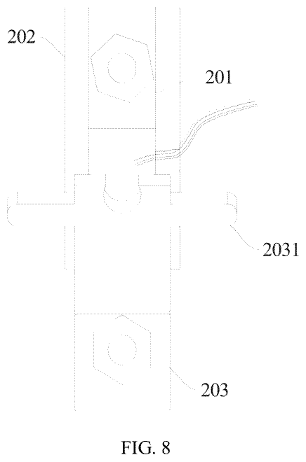

As shown in FIG. 4 to FIG. 8, in some embodiments, the force measuring structure 20 includes a first connecting plate 202 and a second connecting plate 203. A first end of the first connecting plate 202 is connected to a first end of the sensor 201, a first end of the second connecting plate 203 is connected to a second end of the sensor 201, and a second end of the second connecting plate 203 is rotatably connected to the housing 10. One end of the traction rope 200 is connected to the second end of the first connecting plate 202. In some embodiments, the sensor 201 includes an elastic body 2011 and a resistance stress sheet 2012 disposed on the elastic body 2011, and the resistance stress sheet 2012 is connected to the detection circuit 1041 through a wire 2013. The elastic body 2011 is elastically deformed under an external force, causing the resistance strain sheet to deform and the resistance value of the resistance strain sheet to change. And then the resistance value of the resistance strain sheet is converted into a corresponding pulling force value by the detection circuit 1041.

When in use, although the pet's moving direction may sway, the force measuring structure 20 is rotatably connected to the housing 10, small-angle sways do not affect the force measurement. Moreover, the owner's arm may adjust correspondingly under the pulling force, compensating large angle changes.

In some embodiments, the second end of the second connecting plate 203 is provided with a rotating shaft 2031, and an inner wall of the first housing 101 and the second housing 102 is defined with an axial hole 1021 respectively. The two axial holes 1021 are arranged opposite to each other. Two ends of the rotating shaft 2031 of the second connecting plate are respectively hinged with the two axial holes 1021.

In some embodiments, the second end of the first connecting plate is provided with a connection point 2021. A line defined by the connection point is perpendicular to the force-bearing surface of the sensor 201. This line intersects and is perpendicular to the axis of the rotating shaft 2031 of the second connecting plate. The traction rope 200 is connected to the connection point, reducing the impact of the inclined or eccentric loads on the measurement accuracy of the sensor 201. In some embodiments, the second end of the first connecting plate 202 is installed with a connecting column 204, and the traction rope 200 is connected to the connecting column 204. An axis of the connecting column 204 is perpendicular to a force-bearing center of the elastic body 2011 and intersects and is perpendicular to an axis of the rotating shaft 2031 of the second connecting plate.

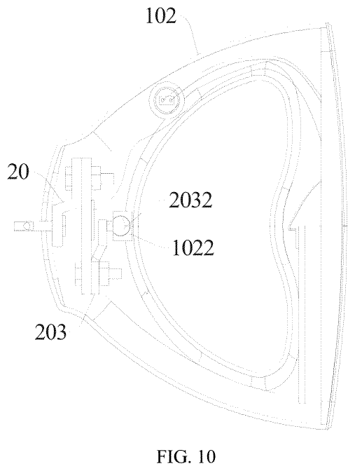

As shown in FIG. 10, in some embodiments, the second end of the second connecting plate 203 is provided with a ball head 2032, and an inner wall of the first housing 101 and the second housing 102 is respectively provided with a hemispherical bowl 1022 arranged oppositely. One ball head 2032 is hinged with the two hemispherical bowls 1022. In the present embodiment, the force measuring structure 20 has more degrees of freedom in the housing 10, which makes the measurement of the sensor 201 relatively more accurate.

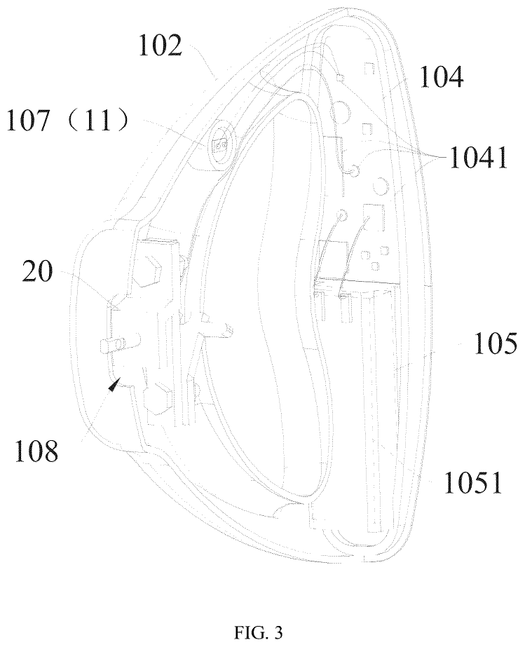

The pet pulling force test device also includes a feedback device 11 for feeding back the pulling force state, which includes but is not limited to at least one of a buzzer 107, a vibration motor, a display screen 1033, and a light. The feedback device 11 is electrically connected to the detection circuit 1041. For example, as shown in FIG. 2 and FIG. 3, the buzzer 107 is installed in the housing 10, and when the pulling force detected by the detection circuit 1041 meets the preset value, the buzzer 107 emits a preset sound. A plurality of preset pulling force values can be set, and corresponding feedback can be made through different sounds.

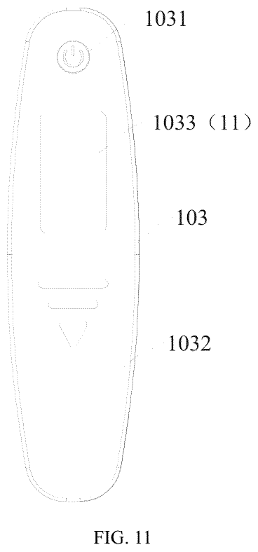

As shown in FIG. 2, FIG. 4 and FIG. 11, in some embodiments, the housing 10 also includes a panel 103, a button 1031 is provided on the panel 103, and the button 1031 is electrically connected to the detection circuit 1041. In some embodiments, the housing 10 is also provided with a battery compartment 105, which can be detachably placed in the battery compartment 105. The battery compartment 105 is electrically connected to the detection circuit 1041. The panel 103 is also provided with a door 1032 of the battery compartment 105, and the door 1032 can be selectively opened to facilitate installation or replacement of the battery 1051 in the battery compartment 105. In some embodiments, the feedback device 11 for feeding back the pulling force state is the display screen 1033 arranged on the panel 103, and the current pulling force value can be intuitively displayed on the display screen 1033.

As shown in FIG. 2 and FIG. 4, in some embodiments, the housing 10 is also provided with a pull ring 106, which can enhance the grip effect and grip force of the housing 10.

Compared to the related art, the embodiments of the present disclosure provide a pulling force test device equipped with a rotatable force measurement structure to reduce the impact of tilted or eccentric loads on the accuracy of sensor. Additionally, the present disclosure reveals various embodiments of the force measurement structure to enhance the accuracy of pulling force detection. Thirdly, the present disclosure allows for multiple feedback mechanisms to respond to the magnitude of the pulling force, enabling users to be aware of the pulling force exerted by their pets.

The above description is only some embodiments of the present disclosure and is not intended to limit the scope of the present disclosure. Any equivalent changes or modifications made according to the structure, characteristics and principles described in the protection scope of the present disclosure should be included in the protection scope of the present disclosure.

What is claimed is:

1. A pulling force test device, comprising:
a force gauge, comprising a housing, a force measuring structure, a detection circuit, a battery and a feedback device for feeding back a pulling force state;
wherein the force measuring structure, the detection circuit, the battery and the feedback device are arranged on the housing; the force measuring structure comprises a sensor for testing a pulling force; the sensor, the feedback device and the battery are respectively electrically connected to the detection circuit; and the force measuring structure is rotatably connected to the housing.

2. The pulling force test device according to claim 1, wherein the housing comprises a first housing and a second housing; the force measuring structure, the detection circuit and the battery are disposed between the first housing and the second housing.

3. The pulling force test device according to claim 1, wherein the force measuring structure comprises a connection point for testing the pulling force, and a line defined by the connection point and a rotation center of the force measuring structure is perpendicular to a force-bearing surface of the sensor.

4. The pulling force test device according to claim 1, wherein the feedback device comprises at least one of a buzzer, a vibration motor, a display screen, and a light.

5. The pulling force test device according to claim 1, wherein the housing further comprises a panel, the panel is provided with a button, the button is electrically connected to the detection circuit; or/and
the housing is further provided with a battery compartment, the battery compartment is provided with a door, the battery is detachably disposed in the battery compartment, and the battery compartment is electrically connected to the detection circuit; or/and
the housing is further provided with a pull ring.

6. The pulling force test device according to claim 1, further comprising a traction rope, wherein one end of the traction rope is connected to a connection point of the force gauge, and another end of the traction rope is configured to attach to a pet.

7. The pulling force test device according to claim 6, wherein the housing is defined with a through hole, and one end of the traction rope is capable of being connected to the connection point of the force measuring structure through the through hole.

8. The pulling force test device according to claim 1, wherein the force measuring structure further comprises a first connecting plate and a second connecting plate, a first end of the first connecting plate is connected to a first end of the sensor, a first end of the second connecting plate is connected to a second end of the sensor, and a second end of the second connecting plate is rotatably connected to the housing.

9. The pulling force test device according to claim 8, wherein the second end of the second connecting plate is hinged to the housing.

10. The pulling force test device according to claim 9, wherein the second end of the second connecting plate is provided with a rotating shaft, the housing is defined with an axial hole, and the rotating shaft is hinged with the axial hole; or
the second end of the second connecting plate is provided with a ball head, the housing is defined with a bowl, and the ball head is hinged with the bowl.
